(19) United States
(12) Patent Application Publication
(10) Pub. No.: US 2018/0295869 A1
(43) Pub. Date: Oct. 18, 2018

(54) AN EDIBLE COMPOSITION

(71) Applicants: BACIAMI PTY LIMITED, CROYDON, NEW SOUTH WALES (AU); J. & R. PEC PTY LIMITED, LEICHHARDT, NEW SOUTH WALES (AU)

(72) Inventors: Salvatore Villa, Croydon, New South Wales (AU); EDWARD MCDONALD, JAMISONTOWN, NEW SOUTH WALES (AU)

(21) Appl. No.: 15/766,281

(22) PCT Filed: Oct. 5, 2016
(86) PCT No.: PCT/AU2016/050935

§ 371 Date: Apr. 5, 2018

(30) Foreign Application Priority Data
Oct. 5, 2015 (AU) 2015904042

(51) Int. Cl. A23L 29/238; A23G 3/40; A23G 3/42; A23G 1/46; A23G 1/48; A23G 1/54; A23L 29/256

(52) U.S. Cl. CPC A23L 29/238; A23G 3/40; A23G 3/42; A23V 2002/00; A23G 1/48; A23G 1/54; A23L 29/256; A23G 1/46

(57) ABSTRACT

There is provided a food composition comprising at least one edible oil in a gel matrix wherein the composition is a flexible cohesive solid at a temperature in a range of from 3° to 6° C. The composition can contain cocoa solids and/or other edible ingredients such as food pastes, fruit preparations, jams and the like. In at least some embodiments the composition can be provided in sheet form, typically with a thickness in a range of from 2 mm to 6 mm. The composition can be used as a snack by itself or be provided on other food items as an edible layering and further, can be provided in packaged slice form. In a further embodiment there is provided a package of sheets or slice of the composition. There is also described a method for providing the composition.

### FIELD OF THE INVENTION

The present invention relates to an edible composition for use on food items or as a snack.

### BACKGROUND OF THE INVENTION

Chocolate is made from cocoa butter and sugar in combination with other ingredients such as cocoa solids and milk in the case of milk chocolate. White chocolate contains cocoa butter, sugar and milk but no cocoa solids. Milk chocolate, sweet chocolate and dark chocolate, for example, are classified on the basis of their cocoa solids content. Chocolate is normally tempered during the manufacturing process to obtain uniformly small cocoa butter crystals. The tempering process results in a stiff product and provides chocolate with its characteristic “snap” when broken. Various chocolate flavoured spreads and pastes are also commercially known. The spreadability of such pastes and spreads results from substituting at least a large proportion of the cocoa butter with edible oil(s) whereby the pastes and spreads remain in a pliant amorphous form at refrigeration temperatures ready for use.

Jams (jellies) and other types of pastes and spreads such as peanut butter are also known. Peanut butter, for example, is an amorphous paste comprising finely ground or dry roasted peanuts and vegetable oil to provide a creamy texture and for spreadability.

### SUMMARY OF THE INVENTION

The present invention in one or more forms relates to a food composition wherein a liquid component of the composition is stabilised in a gel matrix whereby the food composition is in the form of a flexible cohesive solid.

In particular, in an aspect of the invention there is provided a food composition, comprising at least one edible oil in a gel matrix wherein the composition is a flexible cohesive solid at a temperature in a range of from 3° C. to 6° C.

In another aspect of the invention there is provided a method for providing an edible composition, comprising forming a gel matrix containing at least one edible oil within the matrix to provide the composition wherein the composition is a flexible cohesive solid at a temperature in a range of from 3° C. to 6° C.

Typically, a method embodied by the invention comprises mixing one or more gelling agents with the edible oil to provide a heated mixture of the edible oil and the gelling agent, and cooling the mixture to form the gel matrix.

Typically, the composition embodied by the invention is provided in sheet form and in at least some embodiments, can be provided as a package of the sheets wherein the sheets are peelable from one another in use.

Accordingly, in another aspect there is provided a package of sheets of a food composition, the package having a plurality of the sheets arranged one on another in a stack, and the food composition comprising at least one edible oil in a gel matrix wherein the composition is a flexible cohesive solid at a temperature in a range of from 3° C. to 6° C. whereby the sheets are peelable intact from one another.

Typically, the gel matrix comprises a plurality of gelling agents. In at least some embodiments, the gelling agent(s) are selected from vegetable gums. Typically, the gums are selected from polyelectrolyte and uncharged gums and most usually, the gel matrix comprises a plurality of polyelectrolyte gums and an uncharged gum.

Typically, a composition embodied by the invention also comprises one or more gel promoting agents for promoting the formation of the gel matrix.

Typically, a composition embodied by the invention also comprises water, milk solids and optionally, sweetener (e.g., sugar).

A composition embodied by the invention can also include one or more flavouring agents.

In addition, a composition embodied by the invention may also include cocoa solids for providing chocolate flavouring. Advantageously, by replacing at least some of the cocoa butter of cocoa with at least one edible oil and utilising a gel matrix to stabilise the liquid component of the composition as described herein, the composition can remain a flexible cohesive solid even when refrigerated at a temperature of from 3° C. to 6° C.

In further embodiments, a composition in accordance with the invention can include one or more food pastes (e.g., peanut butter), fruit preserves (i.e., fruit jams or jellies), purees (i.e., fruit or vegetable), fruit mash or pulps, or a combination of ones of the foregoing.

In another aspect of the invention there is provided a food composition having a continuous phase comprising a gel matrix and a discontinuous phase comprising a mixture of at least one edible oil, milk solids, water and emulsifier, and the composition is a flexible cohesive solid at a temperature in a range of from 3° C. to 6° C.

In another aspect of the invention there is provided a cocoa based food composition having a continuous phase comprising a gel matrix and a discontinuous phase comprising a mixture of cocoa solids, at least one edible oil, milk solids, water and emulsifier, and the composition is a flexible cohesive solid at a temperature in a range of from 3° C. to 6° C.

In particularly preferred embodiments, a method of the invention comprises:

preparing an aqueous mixture comprising milk solids and the gelling agent;

heating the aqueous mixture to a predetermined temperature with mixing to provide an essentially homogenous gelling mixture;

heating the oil to a predetermined temperature;

mixing the heated oil with the gelling mixture to provide a combined said heated mixture of the oil and the gelling agent, the combined mixture including emulsifier and at least one gel promoting agent for promoting formation of a gel matrix from the gelling agent; and

cooling the combined mixture to form the gel matrix.

As a composition embodied by the invention can remain flexible at low temperatures, sheets of the composition can be stored in a refrigerator ready for immediate use without becoming stiff and brittle as with conventional chocolate. Typically also, the sheets can remain in the form of a cohesive solid and so retain their shape and sufficient firmness for being handled at normal room temperatures in use. In at least some forms, a composition of the invention may retain its cohesiveness when unrefrigerated for a number of hours (e.g., 2, 3, 4, 5 or 6 hours or more) at normal ambient temperatures up to about 25° C. or 30° C. or more. A composition in sheet form as described herein can therefore thereby provide a convenient way for the rapid preparation of snacks, lunches and so on without the need for spreading of the composition over the relevant food item as with the use of conventional chocolate flavoured spreads and pastes, and so also avoid the need to dirty knives or other utensils commonly used to apply spreads and pastes. In particular, individual ones of the sheets find particular application as a chocolate flavouring layer in cakes and pastries and, for example, for providing a chocolate flavouring on toast, bread slices (e.g., in sandwiches), bread rolls, wafers, water crackers and other biscuits. Alternatively, the sheets or other forms of a composition embodied by the invention can be consumed individually as a snack or treat item.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers, integers or steps.

Any discussion of documents, acts, materials, devices, articles or the like that has been included in this specification is solely for the purpose of providing a context for the invention. It is not to be taken as an admission that any or all of these matters form part of the prior art base or were common general knowledge in the field relevant to the invention as it existed in Australia or elsewhere before the priority date of this application.

The features and advantages of the present invention will become further apparent from the following detailed description of exemplary, non-limiting embodiments of the invention.

### DETAILED DESCRIPTION OF EXEMPLARY EMBODIMENTS OF THE INVENTION

The gel matrix may be provided by one or more gelling agents that act to stabilise the liquid component in the composition. The gelling agent(s) may, for example, be selected from the group consisting of vegetable gums, pectins (i.e., pectic polysaccharides), cellulose gels (e.g., carboxymethyl cellulose, methyl cellulose), konjac flours, hydrocolloidal polysaccharides, and synthetic gelling agents.

Gelling vegetable gums are particularly suitable for forming the gel matrix of a composition embodied by the invention. Generally, the gel matrix will be formed by a combination of vegetable gums that are selected and utilised in amounts for providing firmness to the composition whist retaining flexibility in the composition at standard refrigeration temperatures in a range of from about 3° C. to about 6° C. and more typically, from about 4° C. to about 5° C.

The term “vegetable gum” as used herein encompasses plant gums and gum derived or developed from plant gum(s), and includes gums from trees, shrubs, seaweeds, and plant seeds, and mixtures of the foregoing.

Suitable vegetable gums which may be utilised in a composition embodied by the invention include natural gums, polyelectrolyte gums, and uncharged gums. Natural polyelectrolyte and natural uncharged gums are particularly preferred although any gums which can provide a gel matrix for immobilising the liquid component of a composition as described herein whilst retaining flexibility at normal domestic refrigerator temperatures can be used.

Typically, a composition in accordance with the invention will contain vegetable gum for providing the gel matrix of the composition in an overall amount in a range of from about 0.5% to about 2.5% by weight of the composition (e.g., 1%, 1.25%, 1.5%, 1.75%, 2%, 2.25% or 2.5% by weight) and most usually, in an amount of from about to 1% to about 2% by weight.

Examples of suitable gums that may be utilised in a composition embodied by the invention include carrageenan gums, alginate gums, galactomannan gums, locust bean gums, and glucomannon gums. Carrageenan gums are examples of polyelectrolyte gums whilst glucomannan gums are examples of uncharged gums.

Typically, gums utilised in a composition in accordance with the invention will be selected from carrageenan gums and galactomannan gums.

Examples of galactomannan gums that may be utilised include locust been gums (also known as carob bean gum), and guar gum and tara gum. Most typically, locust bean gum is included in the composition examples of which include Staycol 912 (Chemiplas Australia, North Ryde. NSW Australia) and Viscogum BJ (Degussa).

Carrageenan gums that may be utilised can be selected from kappa and iota carrageenan gums. Kappa carrageenan gums can form strong, rigid gels in the presence of potassium ions and react with dairy proteins. Iota carrageenan gums can also form gums in the presence of calcium ions such as found in milk or milk powders although the gums are relatively soft compared to kappa carrageenan gums.

Thus, whilst an individual gum may not suitable for immobilising the liquid component of a composition embodied by the invention whilst at the same time allowing the composition to remain flexible at low temperatures as described herein, a combination of vegetable gums may nevertheless be used to provide the gel matrix of a composition embodied by the invention with the requisite stability and flexibility.

Typically, a composition embodied by the invention will comprise kappa carrageenan and iota carrageenan gums in combination with at least one galactomannan gum such as locust bean gum.

In particularly preferred embodiments, the composition will generally include the kappa carrageenan gum(s) in an amount in a range of from about 0% to about 1.5% by weight of the composition (e.g., 0.25%, 0.5%, 0.75%, 1.0%, 1.25%, or 1.5% by weight) and most usually, from about 0% to about 1.0%.

Typically, the composition will comprise the iota carrageenan gum in an amount in a range of from about 0% to about 2.5% by weight (e.g., 0.25%, 0.5%, 0.75%, 1.0%, 1.25%, 1.5%, 1.75%, 2%, 2.25% or 2.5% by weight) of the composition and most usually, from about 0% to about 1.5%.

Examples of kappa carrageenan gums which may be utilised in a composition embodied by the invention include Gelcarin gums (FMC Biopolymer, Cargill, Kelco). Typically, the kappa carrageenan gum is Gelcarin 812.

Examples of iota carrageenan gums which may be utilised also include Gelcarin gums (FMC Biopolymer, Cargill, Kelco) such as Gelcarin 379.

Typically, the galactomannan gum will be present in an amount in a range of from about 0% to about 1.5% by weight of the composition (e.g., 0.25%, 0.5%, 0.75%, 1.0%, 1.25%, or 1.5% by weight) and most usually, from about 0% to about 0.5%.

A composition embodied by the invention can also include one or more gel promoting agents for promoting formation of the gel matrix from the selected gelling agent(s) utilised. In at least some embodiments the gel promoting agent can be a source of monovalent metal ions such as sodium or potassium cation, or a source of divalent metal cations such as calcium. When the composition comprises a kappa carrageenan gum a gel promoting agent in the form of a potassium salt such as a potassium salt of a food acid (e.g., potassium citrate, potassium tartrate etc.) will generally be utilised. For iota carrageenan gums and other vegetable gums or gelling agents for which calcium promotes formation of a gel from the agent, sufficient calcium cations may be provided by the inclusion of milk powder in the composition.

A composition embodied by the invention may include milk solids provided by a milk source such as a milk powder prepared from a milk with reduced fat content in order to minimise the content of fats in the composition which may solidify at low temperature at which a composition of the invention may be stored and thereby reduce the flexibility of the composition. The milk solids may, for instance, be selected from the group consisting of skim milk, fat reduced milk, and non-fat milk powders. Typically, a milk powder utilised in a composition in accordance with the invention will be prepared from a milk with a fat content of less than about 3.25% by weight (e.g., 3.25%, 3.0%, 2.75%, 2.5%, 2.25%, 2%, 1.75%, 1.5%, 1.25%, 1%. 0.75%, 0.5%, 0.25% or essentially nil by weight), more usually a fat content of about 2% be weight or less and most usually, a fat content of about 1% by weight or less. Skim milk powder is particularly preferred.

Typically, a milk powder will be utilised in the composition in an amount of from about 4% to about 30% by weight of the composition (e.g., 4.5%, 5%, 5.5%, 6%, 6.5%, 7%, 7.5%, 8%, 8.5%, 9%, 9.5% 10%, 11%, 12%, 13%, 14%, 15%, 16%, 17%, 18%, 19%, 20%, 21%, 22%, 23%, 24%, 25%, 26%, 27%, 28%, 29% or 30% by weight), more usually from about 7.5% to about 25% by weight and most usually, from about 10% to about 20% by weight.

An edible oil used in a composition in accordance with the invention can be an animal (e.g., duck or chicken oil), vegetable or synthetic oil. Typically, vegetable oils are utilised in food composition although in some forms, combinations of animal and vegetable oils may be employed.

Typically, a composition embodied by the invention will include one or more edible oils in an overall amount in a range of from about 1.5% to about 30% by weight of the composition (e.g., 1.5%, 1.75%, 2.0%, 2.25%, 2.5%, 2.75%, 3.0%, 3.25%, 3.5%, 3.75%, 4.0%, 4.25%, 4.5%, 4.75%, 5.0%, 5.25%, 5.5%, 5.75%, 6%, 6.25%, 6.5%, 6.75%, 7%, 7.25%, 7.5%, 7.75%, 8%, 8.25%, 8.5%, 8.75%, 9%, 9.25%, 9.5%, 9.75%, 10%, 15%, 20%, 25% or 30% by weight), more usually from about 3.5% to about 25% by weight and most usually, from about 4.5% to about 20% by weight.

As with vegetable gums, the term “vegetable oil” encompasses oil derived from a plant, or which is otherwise developed from a plant (e.g., and/or seeds) or from plant oil(s), and includes hydrogenated and partially hydrogenated plant oils, and mixtures of the foregoing. A vegetable oil utilised in a composition embodied by the invention will normally have a high fats content such as coconut oil, palm oil, olive oil, canola (rapeseed) oil, safflower and sunflower oils with high oleic acid content, and hydrogenated cotton seed oil. Typically, the vegetable oil will have a high monounsaturated or saturated fatty acid content. Coconut oil has a high content of saturated fatty acid and its use is preferred in at least some embodiments of the invention.

The term “cocoa solids” as used herein is to be taken to mean solids remaining after cocoa butter is extracted from the cocoa bean, and encompasses cocoa powders and solids conventionally used in the provision of chocolates and chocolate flavoured foods. Typically, the cocoa solids utilised in a composition as described herein will be in the form of a cocoa powder.

Chocolate flavoured embodiments of compositions in accordance with the invention will typically have a cocoa solids content in a range of from about 0.5% to about 10% by weight of the composition (e.g., 0.5%, 0.75%, 1%, 1.25%, 1.5%, 1.75%, 2.0%, 2.25%, 2.5%, 2.75%, 3.0%, 3.25%, 3.5%, 3.75%, 4.0%, 4.25%, 4.5%, 4.75%, 5.0%, 5.25%, 5.5%, 5.75%, 6%, 6.25%, 6.5%, 6.75%, 7%, 7.25%, 7.5%, 7.75%, 8%, 8.25%, 8.5%, 8.75%, 9%, 9.25%, 9.5%, 9.75%, or 10% by weight), more usually in an amount from about 1% to about 8% by weight and most usually, in an amount from about 1.5% to about 5% by weight.

Typically, cocoa butter may comprise up to about 25% of weight of the cocoa solids (e.g., 25%, 24.5%, 24%, 23.5%, 23%, 22.5%, 22%, 21.5%, 21%, 20.5%, 20%, 19%, 18%, 17%, 16%, 15%, 14%, 13%, 12%, 11%, 10%, 9%, 8%, 7%, 6%, 5%, 4%, 3%, 2%, 1% or essentially nil by weight) and more generally, about 22% by weight of the cocoa solids or less.

More generally, compositions embodied by the invention may comprise cocoa butter in an amount of from 0% to about 5% by weight of the composition (e.g., nil, 0.25%, 0.5%, 0.75%, 1.0%, 1.25%, 1.5%, 1.75%, 2%, 2.25%, 2.5%, 2.75%, 3%, 3.25%, 3.5%, 3.75%, 4%, 4.25%, 4.5% or 5% by weight), more usually up to about 4% by weight of the composition and most usually, up to about 2.5% by weight of the composition.

In chocolate flavoured compositions embodied by the invention containing cocoa powder in the absence of peanut butter or like foods such as jams and fruit purees as described above, the edible oil component of the composition may at least partially be in the form of shortening to provide more firmness to the composition. In at least some embodiments, shortening may comprise from about 2% to about 25% by weight of the composition (e.g., 2%, 2.5%, 3%, 3.5%, 4%, 4.5%, 5%, 5.5%, 6%, 6.5%, 7%, 7.5%, 8%, 8.5%, 9%, 9.5%, 10%, 11%, 12%, 13%, 14%, 15%, 16%, 17%, 18%, 19%, 20%, 21%, 22%, 23%, 24% or 25% by weight) and more usually, from about 3% to about 20% by weight of the composition. Thus, for instance, where a composition as described herein comprises shortening in an amount of 20% by weight, the composition may contain edible oil in a further amount of up to 10% by weight of the composition. The shortening used in a composition embodied by the invention can be animal, vegetable and/or synthetic in origin. Typically, the shortening is vegetable shortening.

In addition, a composition embodied by the invention can also include water, emulsifier, sweetener and optionally, one or more flavouring agents.

Typically, the composition will include water in an amount of from about 10% to about 45% by weight of the composition (e.g., 10%, 15%, 20%, 25%, 30%, 35%, 40%, or 45% by weight), more usually from about 15% to about 35% by weight and most usually, from about 20% to about 33% by weight.

The sweetener can be any natural carbohydrate sweetener although artificial sweeteners can also be employed. Natural carbohydrate sweeteners include monosaccharides, disaccharides and oligosaccharides, and combinations thereof. Generally, the sweetener used in a composition of the invention is a disaccharide and most usually is sucrose. The sucrose can be in a form such as refined table sugar, raw sugar, or for instance, castor sugar.

Typically, the composition will comprise sugar (e.g., sucrose) in an amount of from about 10% to about 50% by weight of the composition (e.g., 10%, 12.5%, 15%, 17.5%, 20%, 25%, 30%, 35%, 40%, 45% or 50% by weight), more usually from about 15% to about 40% by weight and most usually, from about 20% to about 30% by weight.

The emulsifier can be any emulsifier or combination of food emulsifiers that are compatible with the vegetable oil and vegetable gum components of the composition and may, for instance, be selected from the group consisting of lecithins, monoglycerides and their derivatives, sorbitan derivatives and polyglycerol esters. Lecithin emulsifiers include soybean lecithin, egg lecithin, milk lecithin, and other plant derived lecithins such as those extracted from sunflower, cottonseed and canola.

The flavouring agent can be a natural flavouring agent or an artificial flavourant. Natural flavouring agents may comprise or consist of an essential oil, oleoresin, essence, extract, protein hydrolysate, or a distillate. Artificial flavouring agents or flavourants that may be utilised include ester preparations well known to persons of ordinary skill in the art. The flavouring agent may, for example, be selected to provide vanilla (e.g., vanillin or ethyl vanillin), mint, orange, banana and pear flavours.

Emulsifier and such flavouring agents will generally each respectively be included in a composition in accordance with the invention in an amount of about 2.5% by weight of the composition or less (e.g., 2.5%, 2.25%, 2%, 1.75%, 1.5%, 1.25%, 1%, 0.75%, 0.5%, or 0.25% or less by weight) and most usually, in an amount of about 1.5% by weight or less.

Other food ingredients that can be included in a composition in accordance with the invention include food pastes, fruit preparations (e.g., of strawberry, raspberry, blue berries, mixed berries, dates etc.), fruit preserves such as jams (i.e., jellies), purees of fruits and/or vegetables, fruit mash or pulps, emulsions, and other ingredients or preparations which impart the desired flavour, texture and/or consistency to the composition e.g., such as nuts (almonds, peanuts etc.), and coffee flavoured preparations (e.g., coffee or coffee bean extracts).

Further, for example, in one or more embodiments, commercially available peanut butter (e.g., smooth peanut butter paste) may be utilised. Peanut butter contains about 50% vegetable oil by weight of the composition, of which typically 60% to 70% by weight is monounsaturated. Further examples of ingredients of this type that may be utilised include jelly preparations (i.e., jam preparations such as strawberry or raspberry jams). Such ingredients can also act as a filler in the composition. Typically, such ingredients, when included in a composition embodied by the invention, will be present in an amount in a range of from 0% to about 35% by weight of the composition (e.g., 0%, 2.5%, 5%, 7.5%, 10%, 12.5%, 15%, 17.5%, 20%, 22.25%, 25%, 27.5% or 30% by weight), more usually in an amount from 0% to about 30% by weight and most usually, in an amount from 0% to about 25% by weight.

As specific examples, when peanut butter paste is included in a composition embodied by the invention, the peanut butter will typically be present in an amount of from about 20% to about 35% by weight. If a fruit jam (jelly) is included, it will typically be present in an amount for from about 10% to about 25% by weight of the composition.

Compositions as described herein may, for example, be chocolate flavoured due to the inclusion of cocoa powder, chocolate and peanut butter flavoured resulting from the inclusion of both cocoa powder and peanut butter, and a range of flavours examples of which include, but are not limited thereto, chocolate and banana wherein the banana flavour can e.g., be provided by an ester, ester combination and/or fruit puree, peanut butter and jam (e.g., strawberry) and so on.

As will be understood, ingredients like peanut butter, jams and the like contribute to the edible oil, sweetener, water, gelling agent, emulsifier content and the like of the composition as applicable, and the amounts of the respective components of compositions embodied by the invention as described above include those provided by the peanut butter, jam, pulp, puree or other like component. Jam, for example, typically comprises pectin as a gelling agent and the amount of pectin in any jam included in a composition embodied by the invention in included in the total amount of gelling agent component of the composition as described above.

Compositions in accordance with one or more forms of the invention can also include one or more of fillers, wetting agents, flavour intensifiers (e.g., NaCl), preservatives such as hyroxybenzoate, benzoic acid, sodium benzoate, sulphur dioxide, and sulphites, and antioxidants such as citric acid and tocopherols.

Typically, a method for providing a food composition embodied by the invention includes heating an aqueous mixture comprising the selected gelling agent(s), heating the selected edible oil(s) separately, and mixing the heated aqueous mixture and oil(s) together before transferring the resulting mixture to a mould or tray where it is allowed to cool. The aqueous mixture will typically include other ingredients of the composition such as the selected sweetener (e.g., sugar), the milk solids, gel promoting agent (e.g., potassium citrate), cocoa powder, and the like which are generally water miscible or which can be blended into the aqueous mixture (e.g., fruit jam, jelly, puree, mash etc). An emulsifier such as lecithin and components of the composition that are generally oil miscible or which can otherwise blended together with the oil (e.g., such as peanut butter) are generally heated together with the oil to provide an ‘oil’ mix, and the heated oil mix is added to the aqueous mixture.

The aqueous mixture and the oil mix are each independently heated to a predetermined temperature in a range of from about 75° C. to about 95° C. (e.g., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C. or 95° C.) before being mixed together. In preferred embodiments, the aqueous mixture and the oil mix are both heated to substantially the same temperature. Most typically, the aqueous mixture and the oil are each heated to about 85° C. before being combined together. Most typically, the resulting mixture is maintained at the predetermined temperature whilst the aqueous mixture and the oil/oil mix are mixed together to provide a generally homogeneous resulting mixture which is allowed to cool for subsequent slicing to size as required, individual wrapping and packaging as described above. Whilst not being limited to theory, in embodiments of the invention it has been found that heating the aqueous mixture and the oil mix to within the above temperature range and preferably to about 85° C., is necessary to stabilise the composition and so obtain the flexible, cohesiveness of the composition as described herein.

Whilst a composition embodied by the invention can be in the form of a block, bar or individually wrapped confection such as with conventional chocolates, it will typically be provided in the sheet form. The sheets can be packaged individually or be in the form of a package comprising a plurality of the sheets one on top of another in a stack. When provided as a package of sheets, the sheets can be in direct contact with one another or they can be interleaved by a layer of a suitable foil, paper (e.g., a waxed or other grease-proof or non-stick paper) or film (e.g., a film of a suitable plastics material such as polypropylene, low density polyethylene (LDPE) or linear low density polyethylene (LLDPE)) whereby adjacent ones of the sheets are separated from one another. In either case, however, the flexibility of the composition allows the sheets to be individually peeled intact from the stack or one from one another at the time of use.

A sheet of the composition may be provided in a round, square, rectangular or other shape. The sheets will each generally have a substantially constant thickness in a range of from about 2 mm to about 6 mm (e.g., 2 mm, 2.5 mm, 3 mm, 3.5 mm, 4 mm, 4.5 mm, 5 mm, 5.5 mm or 6 mm), more usually in a range of from about 3 mm to 5 mm, and be from about 10 cm² to about 350 cm² in area and more usually, from about 50 cm2 to about 175 cm² in area. Typically, the sheets are provided as squares of a size for substantially covering a cracker or slice of bread or be in round form for use as a covering or layering for a pastry or cake.

Typically, a composition embodied by the invention will have firmness, consistency and flexibility the same as, or similar to, conventional pre-packaged commercially available cheese slices. Advantageously, at least some compositions embodied by the invention may remain in the form of a flexible, cohesive solid over a wide temperature range (including below 0° C.) allowing sheets/slices of the composition to be peeled intact from one another when needed in use. For example, at least some forms of compositions as described herein may remain sufficiently flexible to allow sheets/slices of the compositions to be “peelable” without breaking apart over a temperature range of from about −25° C., −20° C., −15° C., −10° C., −5° C., or 0° C. to about 10° C., 12.5° C., 15° C., 17.5° C., 20° C., 22.5° C., 25° C., 27.5° C. or 30° C.

It will be understood that where ranges of values are described above all individual values and sub-ranges within the specified ranges are expressly encompassed herein. For example, a slice in accordance with the invention can contain cocoa solids in a range of from 0.5% to 10% by weight of the composition, and so includes slices with e.g., 1% to 5%, 2% to 7.3%, or 3% to 8.1% cocoa solids etc.

A sheet of a composition embodied by the invention can be made by mixing the ingredients of the composition together, transferring the mixture to a tray or mould, tamping the mixture down and allowing the mixture to set without tempering of the mixture as described further below with reference to non-limiting embodiments of the invention.

### Example

A chocolate and peanut butter flavoured composition in accordance with the invention was prepared as follows. The ingredients of the composition are shown in Table 1 below. All amounts shown are percentage by weight of the composition.

TABLE 1
Ingredients

| Ingredients of compositions | Weight (gm) | % w/w |
|---|---|---|
| Water | 350.00 | 32.9567 |
| Sugar (sucrose) | 270.00 | 25.4237 |
| Peanut butter paste (smooth) | 230.00 | 21.6573 |
| Skim milk powder | 110.00 | 10.3578 |
| Coconut oil | 55.00 | 5.1789 |
| Cocoa powder | 25.00 | 2.3540 |
| Gelcarin 379 | 10.00 | 0.9416 |
| Soy lecithin | 5.00 | 0.4708 |
| Gelcarin 812 | 3.00 | 0.2825 |
| Locust bean gum | 3.00 | 0.2825 |
| Potassium citrate | 0.50 | 0.0471 |
| Vanilla flavour (natural) | 0.50 | 0.0471 |

The skim milk powder, cocoa powder, potassium citrate and approximately two thirds of the sugar are mixed together to initially provide a “dry mix”. The remainder of the sugar is separately combined with the locust bean gum and the carrageenan gums Gelcarin 379 and Gelcarin 812 with mixing to ensure even dispersions of the gums. The water is added to a jacketed mixing vessel. The sugar and vegetable gum mix is then added to the remainder of the dry mix and added to the mixing vessel. The water and dry mix combination is heated to 85° C. while being mixed to provide a homogenised mixture with a smooth texture. The viscosity of the mixture increases as the temperature rises above 75° C. To ensure homogenisation, the dry sugar and vegetable gum mixture can instead be added to the water and other components of the dry mix during the heating process using a quick mixer or the like. The wetted dry mix can also be passed through a homogeniser (e.g., an in-line homogeniser pump or plunge type homogeniser) to ensure a smooth texture.

The peanut butter, coconut oil, lecithin and vanilla flavour (the “oil mix”) are added to a separate jacketed mixing vessel and also heated to 85° C. with stirring.

Once both mixes are at 85° C., the oils mix is mixed slowly into the homogenised mixture comprising the wetted dry mix using an in-line homogeniser or via the mixing zone of a plunge style homogeniser whilst maintaining the batch temperature at 85° C. to ensure the resulting final mix has a smooth texture.

The final mixture is then transferred into moulds heated to 85° C. and tamped down to form sheets having a thickness of approximately 3 mm. The sheets are allowed to cool below 50° C. before de-moulding. Once de-moulded, the sheets are cut to size and/or stacked together wherein the sheets are interleaved with suitable paper or plastic sheets, prior to packaging and storage in a cool-room at or below 5° C. The sheets remain flexible at the refrigerated temperature so as to be peelable intact from one another, and have a consistency and firmness enabling the sheets to remain intact as a cohesive whole when handled in use.

Other compositions embodied by the invention as described above can be prepared by providing a heated aqueous mixture and adding a heated ‘oil mix’ comprising ingredients of the composition that are oil miscible and/or which can be blended together with the oil, before mixing the resulting combined mixture together and transferring the mixture to tray(s) and/or mould(s) for cooling of the composition, and slicing, individually wrapping, and packaging of the composition.

Although a number of embodiments of the invention have been described above, it will be understood that various modifications and changes may be made thereto without departing from the scope of the invention. Hence, the embodiments described above are only illustrative and not to be taken as being restrictive.

1. A food composition, comprising at least one edible oil in a gel matrix wherein the composition is a flexible cohesive solid at a temperature in a range of from 3° to 6° C.

2. The composition according to claim 1, being in the form of a sheet.

3. The composition according to claim 2, wherein the thickness of the sheet is in a range of from about 3 mm to about 6 mm.

4. (canceled)

5. The composition according to claim 1, wherein the gel matrix is a vegetable gum matrix comprising a plurality of vegetable gums.

6. The composition according to claim 5, wherein the vegetable gum matrix comprises vegetable gums selected from polyelectrolyte and uncharged vegetable gums.

7. The composition according to claim 6, wherein the vegetable gum matrix comprises a plurality of polyelectrolyte gums and an uncharged vegetable gum.

8. (canceled)

9. The composition according to claim 7, wherein the polyelectrolyte gums comprise a kappa carrageenan gum and an iota carrageenan gum.

10. The composition according to claim 9, wherein the uncharged vegetable gum is a locust bean gum.

11. (canceled)

12. The composition according to claim 1, further comprising water, milk solids and sweetener.

13. The composition according to claim 1 being a cocoa based food composition.

14. The composition according to claim 13, comprising:
cocoa solids in a range of from about 0.5% to about 10% by weight:
vegetable gums from which the gel matrix is formed in a range of from about 0.5%% to 2.5% by weight;
the edible oil in a range of from about 1.5% to about 30% by weight;
milk solids in a range of from about 4% to about 30% by weight emulsifier; and
water.

15. The composition according to claim 1, further comprising one or more of food pastes, purees, pulps and flavouring agents.

16. A food composition having a continuous phase comprising a gel matrix and a discontinuous phase comprising a mixture of at least one edible oil, milk solids, water and emulsifier, and the composition is a flexible cohesive solid at a temperature in a range of from 3° C. to 6° C.

17. A cocoa based food composition having a continuous phase comprising a vegetable gum gel matrix and a discontinuous phase comprising a mixture of cocoa solids, milk solids, at least one vegetable oil, water and emulsifier, and wherein the composition is a flexible cohesive solid at a temperature in a range of from 3° C. to 6° C.

18. (canceled)

19. A package of food sheets, the package having a plurality of the sheets arranged one on another in a stack, each sheet being an edible composition comprising at least one edible oil in a gel matrix wherein the composition is a flexible cohesive solid at a temperature in a range of from 3° C. to 6° C. whereby the sheets are peelable intact from one another.

20.-23. (canceled)

24. A method for providing an edible composition, comprising forming a gel matrix containing at least one edible oil within the matrix to provide the composition wherein the composition is a flexible cohesive solid at a temperature in a range of from 3° C. to 6° C.

25. The method according to claim 24, comprising:
mixing one or more gelling agents with the edible oil to provide a heated mixture of the edible oil and the gelling agent; and
cooling the mixture to form the gel matrix.

26. (canceled)

27. The method according to claim 25, further comprising:
preparing an aqueous mixture comprising milk solids and the gelling agent;
heating the aqueous mixture to a predetermined temperature with mixing to provide an essentially homogenous gelling mixture;
heating the oil to a predetermined temperature;
mixing the heated oil with the gelling mixture to provide a combined said heated mixture of the oil and the gelling agent, the combined mixture including emulsifier and at least one gel promoting agent for promoting formation of a gel matrix from the gelling agent; and
cooling the combined mixture to form the gel matrix.

28. The method according to claim 27, wherein the predetermined temperature to which the aqueous mixture is heated and the temperature to which the oil is heated are independently in a range of from about 75° C. to about 95° C.

29. (canceled)

30. The method according to claim 29, wherein the aqueous mixture and the oil are each heated to 85° C.

31. The method according to claim 27, wherein the aqueous mixture comprises the gelling agent and the gel promoting agent.

32. The method according claim 27, wherein the aqueous mixture further comprises one or more ingredients selected from sweeteners and cocoa powder.

33. (canceled)

34. The method according to claim 25, wherein the one or more gelling agents comprise gums.

35. The method according to claim 34, wherein the gelling agents comprise a plurality of vegetable gums and the vegetable gums are mixed with the oil.

36. The method according to claim 24, wherein the composition further comprises one or more ingredients selected from the group consisting of shortening, food pastes, fruits, fruit preserves, purees of fruits and/or vegetables, fruit mash, and fruit pulps.

37.-41. (canceled)
